(19) United States
(12) Patent Application Publication
(10) Pub. No.: US 2019/0164088 A1
(43) Pub. Date: May 30, 2019

(54) APPARATUS AND METHOD FOR SCHEDULING TRIP FOR A PLURALITY OF USERS

(71) Applicants: HYUNDAI MOTOR COMPANY, Seoul (KR); KIA MOTORS CORPORATION, Seoul (KR)

(72) Inventors: Yarygina ANASTASIA, Seoul (KR); Jimin HAN, Anyang-Si (KR); Jung Mi PARK, Anyang-Si (KR); Jia LEE, Uiwang-Si (KR)

(21) Appl. No.: 16/104,387

(22) Filed: Aug. 17, 2018

(30) Foreign Application Priority Data
Nov. 27, 2017 (KR) 10-2017-0159491

(51) Int. Cl. G06Q 10/02; G06Q 10/06

(52) U.S. Cl. CPC G06Q 10/02; G06Q 10/063112

(57) ABSTRACT

An apparatus for scheduling a trip for a plurality of users includes: a communication circuit configured to communicate with a plurality of terminals of the plurality of users; a memory; and a processor configured to be electrically connected with the communication circuit and the memory. The processor is further configured to: obtain information about a location of each of the plurality of terminals and information about a task to be performed by each of the plurality of users from the plurality of terminals; classify the plurality of users into user groups based on the information about the location and the information about the task; and provide a trip for each of the classified user group based on locations and tasks of users included in each of the classified user group.

### CROSS-REFERENCE TO RELATED APPLICATION

This application is based on and claims the benefit of priority to Korean Patent Application No. 10-2017-0159491, filed on Nov. 27, 2017, in the Korean Intellectual Property Office, the disclosure of which is incorporated herein in its entirety by reference.

### TECHNICAL FIELD

The present disclosure relates to an apparatus and method for scheduling a trip for a plurality of users when providing a car hailing service.

### BACKGROUND

Recently, there has been a growing interest in a service (hereinafter referred to as “mobility service” for convenience of description), such as car sharing, a car pool, or car hailing, which may use vehicles of service providers or vehicles of others through a simple procedure. The mobility service may be provided through a service provider server and a personal device of a user. For example, the user may input information about a trip he or she wants and may share a vehicle matched with the input information, using the mobility service. The mobility service may be for providing a service in which a plurality of users who input similar trips share one vehicle with each other or one another.

If a service in which the plurality of users share one vehicle with each other or one another is provided, a process of inputting times and destinations they want and grouping them based on the input times and destinations may be requested. If a user wants to perform a specific task (e.g., product purchase, exercise, meal, or the like) irrespective of a place, a process of inputting time and a destination may result in inconvenience to him or her. Since it is difficult to match the plurality of users with each other or one another, the cost of using the mobility service may be increased.

### SUMMARY

The present disclosure has been made to solve the above-mentioned problems occurring in the prior art while advantages achieved by the prior art are maintained intact.

An aspect of the present disclosure provides an apparatus and method for scheduling a trip for a plurality of users to provide a mobility service which may be used at convenience, inexpensive costs by a user by scheduling the trip based on a task he or she wants to perform in the mobility service.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for scheduling a trip for a plurality of users may include: a communication circuit configured to communicate with a plurality of terminals of the plurality of users, a memory, and a processor configured to be electrically connected with the communication circuit and the memory. The processor may be configured to obtain information about a location of each of the plurality of terminals and information about a task to be performed by each of the plurality of users from the plurality of terminals, classify the plurality of users into a user group based on the information about the location and the information about the task, and provide a trip for the classified user group based on locations and tasks of users included in the classified user group.

The processor may be configured to classify a task to be performed by each of the plurality of users based on the information about the location and, if there is a trip corresponding to the classified task, the trip being stored in the memory, provide the trip to a terminal of a user to perform the classified task.

The processor may be configured to classify users who have the same pick-up location among the plurality of users into one user group.

The processor may be configured to classify users who have tasks performable in the same destination into one user group.

The processor may be configured to provide the trip based on similarity of the locations and similarity of the tasks between the users included in the classified user group.

The processor may be configured to suggest one or more destinations for the users to perform the tasks based on the locations and the tasks of the users included in the classified user group and provide the trip for the users to arrive at a destination selected by at least some of the users among the one or more destinations.

The processor may be configured to provide information associated with time and cost required for each of the users to arrive at each of the one or more destinations.

The processor may be configured to group users who have the same pick-up location and have tasks achievable in the same destination, users who have the same pick-up location and have tasks achievable in different destinations, users who have different pick-up locations and have tasks achievable in the same destination, or users who have the different pick-up locations and have tasks achievable in the different destinations, among the plurality of users based on the information about the location and the information about the task.

The processor may be configured to, if the users included in the classified user group have the same pick-up location and have tasks achievable in the same destination, suggest that one of the users performs a task of each of the users.

The processor may be configured to suggest that the other of the users pay cost for the trip.

In an embodiment, the processor may be configured to, if the users included in the classified user group have the same pick-up location and have tasks achievable in the same destination, suggest one or more destinations for performing the tasks based on the same pick-up location.

The processor may be configured to, if the users included in the classified user group have the same pick-up location and have tasks achievable in the same destination and information about a destination designated by one of the users included in the classified user group is obtained, provide the trip for the users to arrive at the designated destination.

The processor may be configured to, if the users included in the classified user group have different pick-up locations and have tasks achievable in the same destination, suggest one or more destinations for the tasks based on a location of each of the users.

The processor may be configured to, if the users included in the classified user group have the same pick-up location and have tasks achievable in different destinations, suggest one or more destinations for the most number of the users to perform the tasks.

The processor may be configured to, if the users included in the classified user group have different pick-up locations and have tasks achievable in different destinations, group users within a specified distance among the users and suggest one or more destinations for the grouped users to perform the tasks.

According to another aspect of the present disclosure, a method for scheduling a trip for a plurality of users may include: obtaining information about a location of each of a plurality of terminals and information about a task to be performed by each of the plurality of users from the plurality of terminals of the plurality of users, classifying the plurality of users into a user group based on the information about the location and the information about the task, and providing a trip for the classified user group based on locations and tasks of users included in the classified user group.

The method may further include classifying a task to be performed by each of the plurality of users based on the information about the location and, if there is a previously stored trip corresponding to the classified task, providing the trip to a terminal of a user to perform the classified task.

The providing may include providing the trip based on similarity of the locations and similarity of the tasks between the users included in the classified user group.

The providing may include suggesting one or more destinations for the users to perform the tasks based on the locations and the tasks of the users included in the classified user group and providing the trip for the users to arrive at a destination selected by at least some of the users among the one or more destinations.

The providing may further include providing information associated with time and cost required for each of the users to each of the one or more destinations.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating an environment in which an apparatus for scheduling a trip for a plurality of users is operated according to an embodiment of the present disclosure;

FIG. 2 is a block diagram illustrating a configuration of an apparatus for scheduling a trip for a plurality of users according to an embodiment of the present disclosure;

FIG. 3 is a flowchart illustrating a method for scheduling a trip for a plurality of users according to an embodiment of the present disclosure;

FIG. 4 is a flowchart illustrating a method for scheduling a trip for a plurality of users according to an embodiment of the present disclosure;

FIG. 5 is a flowchart illustrating a method for scheduling a trip for a plurality of users according to an embodiment of the present disclosure;

FIG. 6 is a flowchart illustrating a method for scheduling a trip for a plurality of users according to an embodiment of the present disclosure;

FIG. 7 is a flowchart illustrating a method for scheduling a trip for a plurality of users according to an embodiment of the present disclosure;

FIG. 8 is a flowchart illustrating a method for scheduling a trip for a plurality of users according to an embodiment of the present disclosure; and

FIG. 9 is a block diagram illustrating a configuration of a computing system according to an embodiment of the present disclosure.

### DETAILED DESCRIPTION

Hereinafter, embodiments of the present disclosure will be described in detail with reference to the accompanying drawings. In adding reference denotations to elements of each drawing, although the same elements are displayed on a different drawing, it should be noted that the same elements have the same denotations. In addition, in describing an embodiment of the present disclosure, if it is determined that a detailed description of related well-known configurations or functions blurs the gist of an embodiment of the present disclosure, it will be omitted.

In describing elements of embodiments of the present disclosure, the terms 1^{st}, 2^{nd}, first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

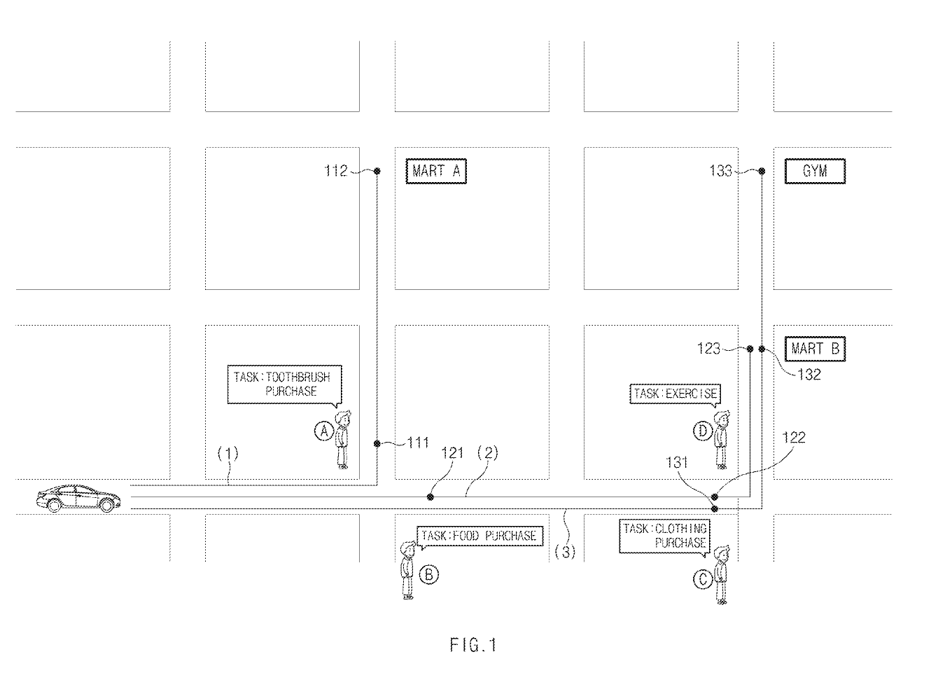

FIG. 1 is a drawing illustrating an environment in which an apparatus for scheduling a trip for a plurality of users is operated according to an embodiment of the present disclosure.

Referring to FIG. 1, an apparatus according to an embodiment may provide a mobility service for a plurality of users. The apparatus may obtain information about a task each of user A, user B, user C, and user D wants to perform and information about a location of each of the terminals of user A, user B, user C, and user D from each of the terminals.

For example, the apparatus may provide a common schedule to user A who wants to perform the task “toothbrush purchase” and user B who wants to perform the task “food purchase”. The apparatus may determine the task of user A and the task of user B as being performable in a mart. User A and user B may be located within a specified distance, and the apparatus may determine that a pick-up location of user A is identical to a pick-up location of user B. The apparatus may provide a schedule, which follows path (1) where a vehicle picks up user A and user B at a first point 111 and where user A and user B alight from a second point 112 at which mart A is located, to user A and user B.

For another example, the apparatus may provide a common schedule to user A who wants to perform the task “toothbrush purchase”, user B who wants to perform the task “food purchase”, and user B who wants to perform the task “clothing purchase”. The apparatus may determine the task of user A, the task of user B, and the task of user C as being performable in a mark. User B and user C may be located to be more distant than a specified distance, and the apparatus may determine that a pick-up location of user B is different from a pick-up location of user C. The apparatus may provide a schedule, which follows path (2) where a vehicle picks up user A and user B at a third point 121, where the vehicle picks up user C at a fourth point 122, and where user A, user B, and user C alight from a fifth point 123 at which mart B is located, to user A, user B, and user C.

For example, the apparatus may provide a common schedule to user C who wants to perform the task “clothing purchase” and user D who wants to perform the task “exercise”. The apparatus may determine a task of user C as being performable in a mark and may determine the task of user D as being performable in a gym. User C and user D may be located within a specified distance, and the apparatus may determine that a pick-up location of user C is identical to a pick-up location of user D. The apparatus may provide a schedule, which follows path (3) where a vehicle picks up user C and user D at a sixth point 131, where user C alights from a seventh point 132 at which mart B is located, and where user D alights from an eighth point 133 at which a gym is located, to user C and user D.

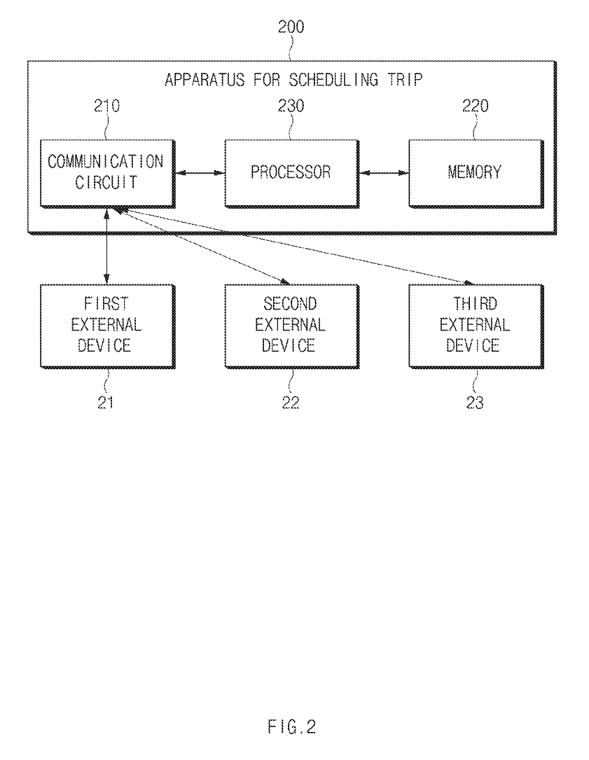

FIG. 2 is a block diagram illustrating a configuration of an apparatus for scheduling a trip for a plurality of users according to an embodiment of the present disclosure.

Referring to FIG. 2, an apparatus 200 for scheduling a trip for a plurality of users (hereinafter referred to as “apparatus 200” for convenience of description) according to an embodiment may include a communication circuit 210, a memory 220, and a processor 230. The apparatus 200 may be, for example, a service provider server for providing a mobility service. As another example, the apparatus 200 may be included in an autonomous vehicle.

The communication circuit 210 may be configured to communicate with a plurality of external devices 21 to 23. In FIG. 2, an embodiment is exemplified as the three external devices 21 to 23. However, embodiments are not limited thereto. For example, the communication circuit 210 may communicate with any number of external devices. The communication circuit 210 may communicate with the external devices 21 to 23 through a server, a mediation device, and/or the like. Each of the external devices 21 to 23 may be a personal terminal of each of the plurality of users.

The memory 220 may include a volatile memory and/or a non-volatile memory. The memory 220 may store data used by an element of the apparatus 200. According to an embodiment, the memory 220 may store a database for determining and classifying a task, a pick-up location, and the like. The memory 220 may store information about a previously provided trip. The memory 220 may store instructions and/or a database for executing operations performed by the processor 230.

The processor 230 may be electrically connected with the communication circuit 210 and the memory 220. The processor 230 may control the communication circuit 210 and the memory 220 and may perform various data processing and various arithmetic operations.

According to an embodiment, the processor 230 may obtain information about a location of each of a plurality of terminals and information about a task to be performed by each of a plurality of users from the plurality of terminals. The processor 230 may obtain location information of each of the plurality of external devices 21 to 23 and task information input by the plurality of users from the plurality of external devices 21 to 23 which are personal terminals of the plurality of users who want to use a mobility service using the communication circuit 210. The processor 230 may obtain information about a plurality of tasks from one external device.

According to an embodiment, the processor 230 may classify a task to be performed by each of the plurality of users based on information about a location. If there is a trip corresponding to the classified task stored in the memory 220, the processor 230 may provide the trip to a terminal of a user to perform the classified task. If there is a trip provided to a user who is located in the same location and wants to perform a task performable in the same destination among previously provided trips, the processor 230 may provide the trip to the plurality of external devices 21 to 23. The above-mentioned operation may be a selective operation and may be omitted according to a form of implementing the present disclosure.

According to an embodiment, the processor 230 may classify the plurality of users based on information about a location and information about a task. For example, the processor 230 may provide a trip based on similarity of locations and similarity of tasks between users included in a classified user group. According to an embodiment, the processor 230 may classify users who have the same pick-up location among the plurality of users into one user group. The processor 230 may determine, for example, that users located within a specified distance among the plurality of users have the same pick-up location. The processor 230 may classify the users located within the specified distance into one user group. According to an embodiment, the processor 230 may classify users who have tasks performable in the same destination into one user group. The processor 230 may determine, for example, a type of a destination for performing a task using a database stored in the memory 220. The processor 230 may classify users who have tasks performable in the same type of destination into one user group.

For example, the processor 230 may group users who have the same pick-up location and have tasks achievable in the same destination among the plurality of users, based on information about a location and information about a task. For another example, the processor 230 may group users who have the same pick-up location and have tasks achievable in different destinations. For another example, the processor 230 may group users who have different pick-up locations and have tasks achievable in the same destination. For another example, the processor 230 may group users who have different pick-up locations and have tasks achievable in different destinations.

According to an embodiment, the processor 230 may provide a trip for a user group classified based on a location and a task of a user included in a classified user group using the communication circuit 210. The processor 230 may provide a trip including a path, a pick-up location, a destination, and the like, in which the user may achieve a task, to a terminal of the user included in the classified user group.

According to an embodiment, the processor 230 may suggest one or more destinations for each of users to perform a task, based on a location and a task of the user included in the classified user group and may provide a trip for the user to arrive at a destination selected by at least some of users among one or more destinations. The processor 230 may determine a category of a place to perform a task based on a database stored in the memory 220 and may suggest a place located on an optimum path among places corresponding to the category as a destination. The processor 230 may provide information associated with time and cost for a user to arrive at each of one or more destinations. For example, the processor 230 may provide information about a time taken to operate a path for reaching a suggested destination and the cost of using a mobility service requested to operate the path. The processor 230 may receive a request for one of one or more destinations from a plurality of external terminals. The processor 230 may determine a path for picking up a user and arriving at a suggested destination and may provide a trip including the path, a pick-up place, and the destination.

According to an embodiment, if users included in a classified user group have the same pick-up location and have tasks achievable in the same destination, the processor 230 may suggest that one of the users performs the task of each of the users. Since a task is easily performed by one person if categories of a pick-up location and a destination are the same as each other, the processor 230 may suggest that one of users included in a user group performs tasks of all of the users included in the user group and that the other of the users included in the user group pay cost for a trip. In this case, the processor 230 may provide a trip for one of the users included in the user group.

According to an embodiment, if users included in the classified user group have the same pick-up location and have tasks achievable in the same destination, the processor 230 may suggest one or more destinations for performing the tasks based on the same pick-up location. If categories of a pick-up location and a destination are the same as each other, the processor 230 may provide a trip, where a vehicle picks up a user included in a user group in the pick-up location and where the user alights from the closest destination to the pick-up location, to the user group.

In an embodiment, if users included in the classified user group have the same pick-up location and have tasks achievable in the same destination and if information about a destination designated by one of the users included in the classified user group is obtained, the processor 230 may provide a trip for the user to arrive at the designated destination. If one of the users included in the user group specifies a task and a destination to perform the task, the processor 230 may provide a trip for reaching the designated destination.

According to an embodiment, if users included in the classified user group have different pick-up locations and have tasks achievable in the same destination, the processor 230 may suggest one or more destinations for performing the task based on a location of each of the users. The processor 230 provides a trip, where a user alights from the destination via a plurality of pick-up locations, to a user group. The processor 230 may exclude a user who has a pick-up location of excessively increasing the cost of using a mobility service among users included in a user group and may schedule a trip.

According to an embodiment, if users included in the classified user group have the same pick-up location and have tasks achievable in different destinations, the processor 230 may suggest one or more destinations for the most number of users to perform the tasks. The processor 230 may provide a trip, where the vehicle passes through a plurality of destinations from the pick-up location, to a user group. The processor 230 may exclude a user who has a task achievable in a destination of excessively increasing the cost of using the mobility service among users included in a user group and may schedule a trip.

According to an embodiment, if users included in the classified user group have different pick-up locations and have tasks achievable in different destinations, the processor 230 may group users located within a specified distance among the users and may suggest one or more destinations for performing for the grouped users to perform the tasks. If both of a pick-up location and a destination are different from each other, the processor 230 may first group users located within a specified distance among users included in a user group. The processor 230 may provide a trip, where a vehicle passes through one or more destinations for performing tasks to be performed by the grouped users from pick-up locations of the grouped users, to the grouped users.

In various embodiments, the communication circuit 210 is a hardware device capable of transmitting an analog or digital signal over wire or wirelessly and may include one or more components that enable communication with external devices. Examples of the communication circuit 210 include Bluetooth devices, infrared devices, modem, network card (using Ethernet), smartphone, Wi-Fi devices (using a Wi-Fi router), etc. Here, the communication circuit 210 may include a communication module that supports a communication interface with electrical equipment and controllers included in the ego vehicle 10. The communication module may include a short-range communication module, wired communication module, wireless communication module, and the like. In addition, the communication module may include a control circuit such as an integrated circuit (IC) chip.

The communication module may include a module supporting a vehicle network communication, such as a controller area network (CAN) communication, a local interconnect network (LIN) communication, a Flex-ray communication, etc.

The communication module may include a module for a wireless internet access or a module for a short range communication. As a wireless internet technology, a wireless LAN (WLAN), a wireless broadband (Wibro), a Wi-Fi, a world interoperability for microwave access (Wimax), and the like may be used, and a Bluetooth, a ZigBee, an ultra wideband (UWB), a radio frequency identification (RFID), an infrared data association (IrDA), and the like may be used as a short range communication technology.

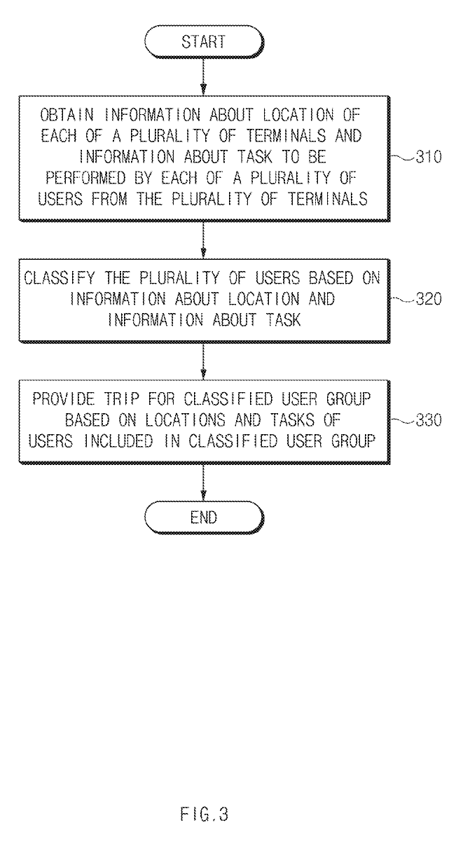

FIG. 3 is a flowchart illustrating a method for scheduling a trip for a plurality of users according to an embodiment of the present disclosure.

All of or a part of the steps method and/or operations of the foregoing embodiments can be realized using computer hardware and computer programs executed thereon.

Hereinafter, it may be assumed that an apparatus 200 of FIG. 2 performs a process of FIG. 3. Further, in a description of FIG. 3, an operation described as being performed by an apparatus may be understood as being controlled by a processor 230 of the apparatus 200.

Referring to FIG. 3, in operation 310, the apparatus may obtain information about a location of each of a plurality of terminals and information about a task to be performed by each of a plurality of users from the plurality of terminals. For example, the apparatus may obtain task information respectively input to the plurality of terminals by the plurality of users and may obtain location information obtained by a global positioning system (GPS) module of each of the plurality of terminals.

In operation 320, the apparatus may classify the plurality of users based on the information about the location and the information about the task. For example, the apparatus may classify users who have the same pick-up location into one user group and may classify users who have tasks performable in the same destination into one user group.

In operation 330, the apparatus may provide a grip for the classified user group based on locations and tasks of users included in the classified user group. For example, the apparatus may determine one or more pick-up devices of users included in the user group and one or more destinations for performing tasks and may provide a trip, which follows a path where a vehicle passes through the one or more determined pick-up locations and the one or more determined destinations, to terminals of the users included in the user group.

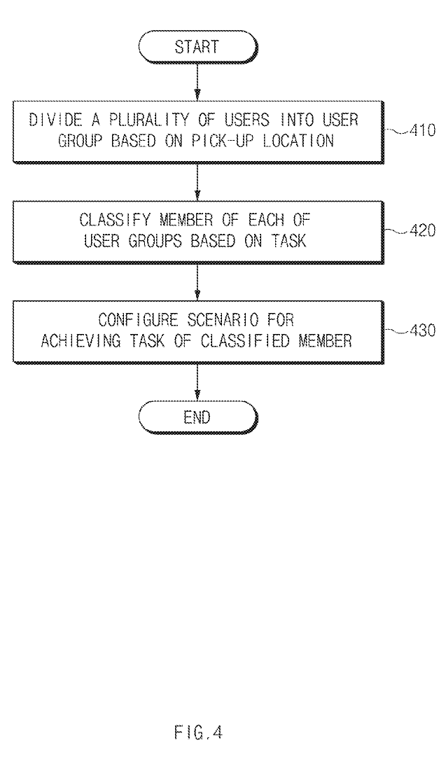

FIG. 4 is a flowchart illustrating a method for scheduling a trip for a plurality of users according to an embodiment of the present disclosure.

Hereinafter, it may be assumed that an apparatus 200 of FIG. 2 performs a process of FIG. 4. Further, in a description of FIG. 4, an operation described as being performed by an apparatus may be understood as being controlled by a processor 230 of the apparatus 200.

Referring to FIG. 4, in operation 410, an apparatus may divide a plurality of users into a user group based on a pick-up location. For example, the apparatus may determine a pick-up location based on location information obtained from a user terminal and may generate a user group having the same pick-up location or may generate a user group having different pick-up locations.

In operation 420, the apparatus may classify members of each of user groups based on a task. For example, the apparatus may determine a category of a place for performing a task based on task information obtained from the user terminal and may generate a user group which may perform a task in the same destination or may generate a user group which may perform a task in different destinations.

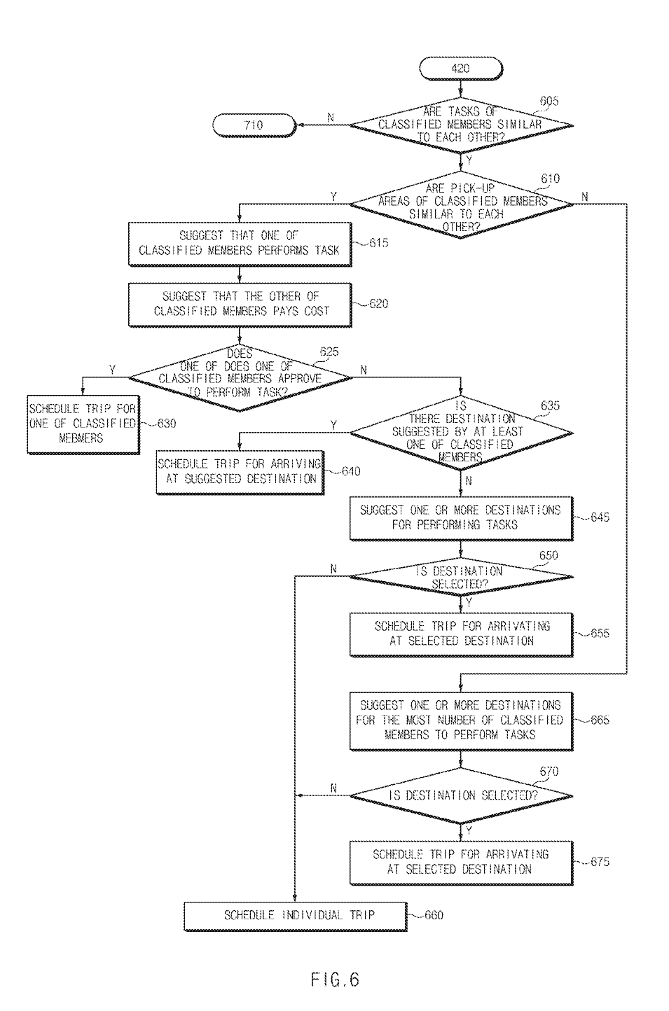

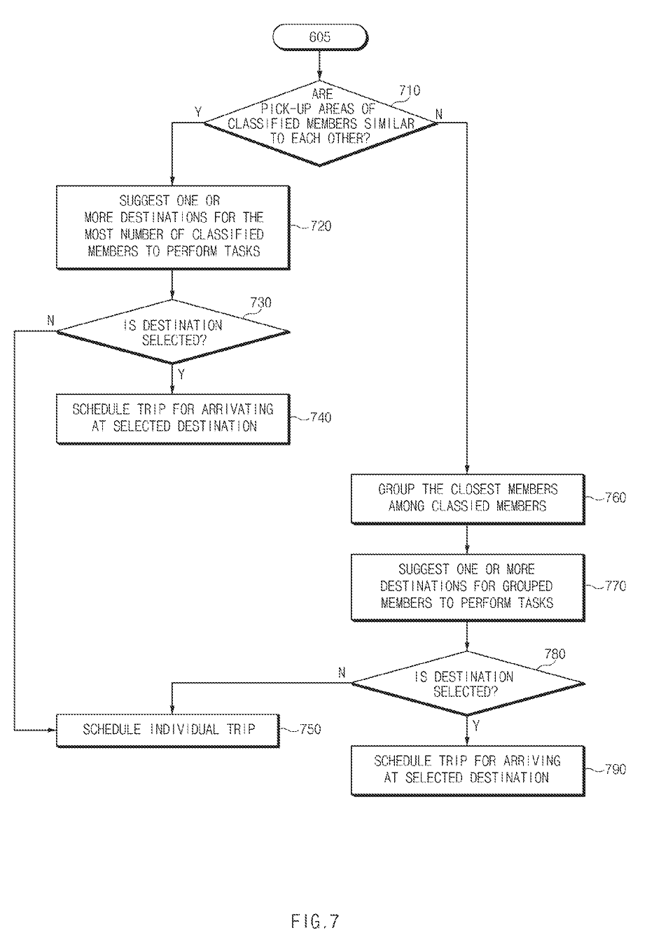

In operation 430, the apparatus may configure a scenario for achieving a task of the classified member. For example, the apparatus may configure a scenario of picking up the classified member and delivering the classified member to a place for performing the task. A description will be given in detail of a detailed method for configuring the scenario with reference to FIGS. 6 and 7.

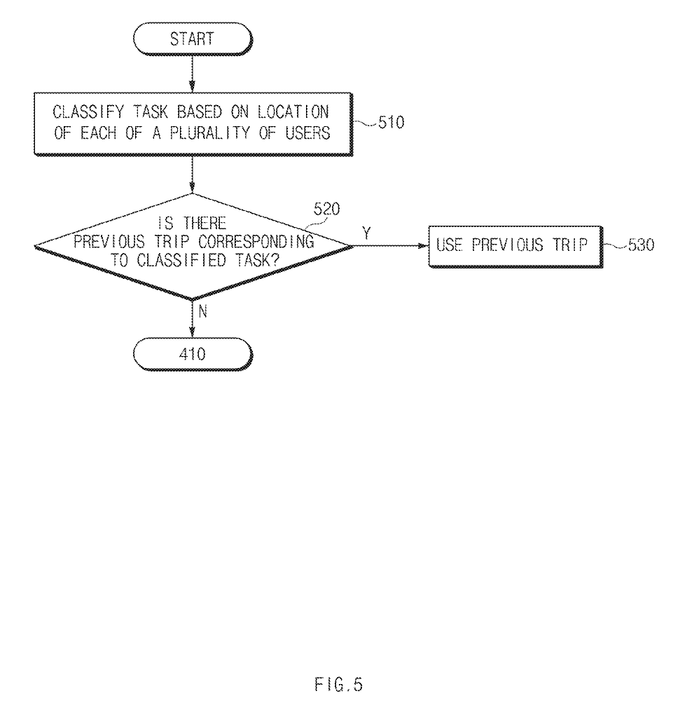

FIG. 5 is a flowchart illustrating a method for scheduling a trip for a plurality of users according to an embodiment of the present disclosure.

Hereinafter, it may be assumed that an apparatus 200 of FIG. 2 performs a process of FIG. 5. Further, in a description of FIG. 5, an operation described as being performed by an apparatus may be understood as being controlled by a processor 230 of the apparatus 200.

Referring to FIG. 5, in operation 510, an apparatus may classify a task based on a location of each of a plurality of users. For example, the apparatus may map a location of each of the plurality of users to a task of each of the plurality of users and may classify the task with respect to the location.

In operation 520, the apparatus may determine whether there is a previous trip corresponding to the classified task. For example, the apparatus may determine whether a trip for performing the task in the location is previously provided and whether the provided previous strip is stored.

In operation 530, the apparatus may use the previous trip. For example, the apparatus may provide the same trip as the previous trip to the plurality of users without a separate procedure.

FIG. 6 is a flowchart illustrating a method for scheduling a trip for a plurality of users according to an embodiment of the present disclosure.

Hereinafter, it may be assumed that an apparatus 200 of FIG. 2 performs a process of FIG. 6. Further, in a description of FIG. 6, an operation described as being performed by an apparatus may be understood as being controlled by a processor 230 of the apparatus 200.

Referring to FIG. 6, after performing operation 420 of FIG. 4, in operation 605, the apparatus may determine whether tasks of classified members are similar to each other. For example, the apparatus may determine whether to perform tasks of the classified members in the same place.

If the tasks are similar to each other, in operation 610, the apparatus may determine whether pick-up areas of the classified members are similar to each other. For example, the apparatus may determine whether locations of the classified members are within a specified distance.

If the tasks are different from each other, the apparatus may perform operation 710 shown in FIG. 7.

If the pick-up areas are similar to each other, in operation 615, the apparatus may suggest that one of the classified members performs a task. For example, if the classified members have the same pick-up location and have tasks performable in the same destination, the apparatus may suggest that one of the classified members performs a task for convenience.

In operation 620, the apparatus may suggest that the other of the classified members pay cost. For example, the apparatus may suggest that the other except for the user to perform the task pay the cost of using a mobility service.

In operation 625, the apparatus may determine whether one of the classified members approves to perform a task. For example, the apparatus may receive an approval message from a terminal of one of the classified terminals.

If the one of the classified members approves to perform the task, in operation 630, the apparatus may schedule a trip for one of the classified members. For example, the apparatus may schedule a trip of delivering one of the classified members from pick-up locations of the classified members to a destination for performing tasks of the classified members.

If the one of the classified members does not approve to perform the task, in operation 635, the apparatus may determine whether there is a destination suggested by at least one of the classified members. For example, the apparatus may determine whether one of the classified members specifies a task to be performed and a place to perform the task.

If there is the suggested destination, in operation 640, the apparatus may schedule a trip for arriving at the suggested destination. For example, the apparatus may schedule a trip of delivering the classified members from pick-up locations of the classified members to the suggested destination.

If there is no the suggested destination, in operation 645, the apparatus may suggest one or more destinations for performing tasks. For example, the apparatus may suggest one or more destinations adjacent to pick-up locations of the classified members. The apparatus may provide information about time and cost required for a trip for each of the one or more destinations.

In operation 650, the apparatus may determine whether the destination is selected. For example, the apparatus may receive a selection message for one of the one or more destinations from terminals of the classified members.

If the destination is selected, in operation 655, the apparatus may schedule a trip for arriving at the selected destination. For example, the apparatus may schedule a trip of delivering the classified members from pick-up locations of the classified members to the selected destination.

If the destination is not selected, in operation 660, the apparatus may schedule an individual trip. For example, the apparatus may separately provide a trip for each of the classified members.

If the pick-up areas of the classified members are different from each other, in operation 665, the apparatus may suggest one or more destinations for the most number of the classified members to perform tasks. For example, the apparatus may exclude a user who has a pick-up location for excessively increasing time and/or cost required among the classified members and may schedule a trip. The apparatus may suggest the one or more destinations adjacent to pick-up locations of the other of the classified members (all of the classified members if a specific user is not excluded). The apparatus may provide information about time and cost required for a trip for each of the one or more destinations.

In operation 670, the apparatus may determine whether the destination is selected.

If the destination is selected, in operation 675, the apparatus may schedule a trip for arriving at the selected destination. For example, the apparatus may schedule a trip of delivering the classified members to the selected destination via a plurality of pick-up locations of the classified members.

If the destination is not selected, the apparatus may perform operation 660.

FIG. 7 is a flowchart illustrating a method for scheduling a trip for a plurality of users according to an embodiment of the present disclosure.

Hereinafter, it may be assumed that an apparatus 200 of FIG. 2 performs a process of FIG. 7. Further, in a description of FIG. 7, an operation described as being performed by an apparatus may be understood as being controlled by a processor 230 of the apparatus 200.

Referring to FIG. 7, if determining that tasks of classified members are different from each other in operation 605, in operation 710, the apparatus may determine whether pick-up areas of the classified members are similar to each other.

If the pick-up areas are similar to each other, in operation 720, the apparatus may suggest one or more destinations for the most number of the classified members to perform tasks. For example, the apparatus may exclude a user who has a task of excessively increasing time and/or cost required among the classified members and may schedule a trip. The apparatus may suggest one or more destinations adjacent to pick-up locations of the other of the classified members (all of the classified members if a specific user is not excluded). The apparatus may provide information about time and cost required for a trip for each of the one or more destinations.

In operation 730, the apparatus may determine whether the destination is selected.

If the destination is selected, in operation 740, the apparatus may schedule a trip for arriving at the selected destination. For example, the apparatus may schedule a trip for delivering the classified members from pick-up locations of the classified members to a plurality of destinations for performing different tasks.

If the destination is not selected, in operation 750, the apparatus may schedule an individual trip.

If the pick-up areas are different from each other, in operation 760, the apparatus may group the closest members among the classified members. For example, the apparatus may group the closest members based on location information obtained from terminals of the classified members. The apparatus may group members located within a specified distance. In this case, pick-up locations of the grouped members may be the same as each other.

In operation 770, the apparatus may suggest one or more destinations for the grouped members to perform tasks. For example, the apparatus may suggest one or more destinations adjacent to pick-up locations of the grouped members.

In operation 780, the apparatus may determine whether the destination is selected. If the destination is selected, in operation 790, the apparatus may schedule a trip for arriving at the selected destination. For example, the apparatus may schedule a trip of delivering the classified members from the pick-up locations of the grouped members to the selected destination.

If the destination is not selected, the apparatus may perform operation 750.

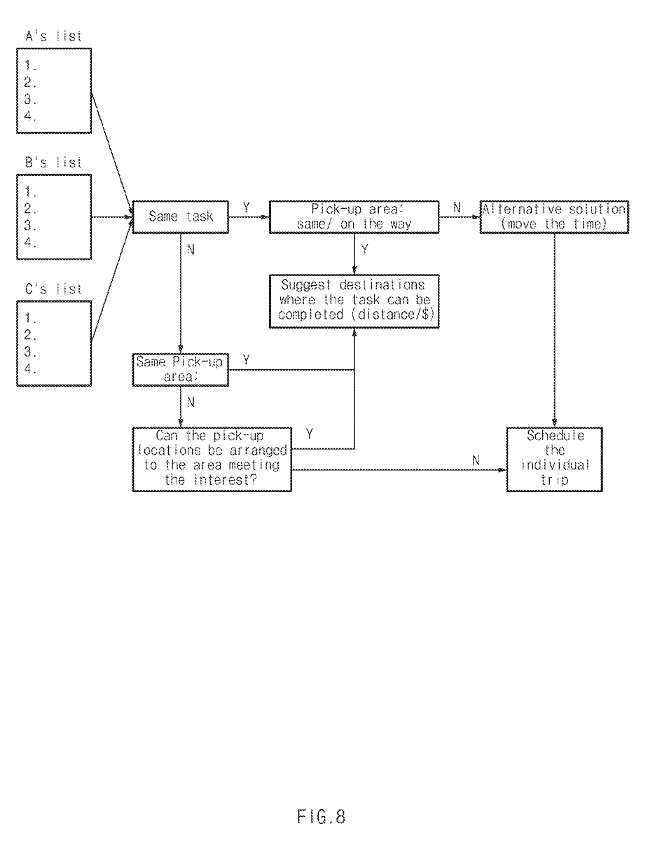

FIG. 8 is a flowchart illustrating a method for scheduling a trip for a plurality of users according to an embodiment of the present disclosure.

Hereinafter, it may be assumed that an apparatus 200 of FIG. 2 performs a process of FIG. 8. Further, in a description of FIG. 8, an operation described as being performed by an apparatus may be understood as being controlled by a processor 230 of the apparatus 200.

Referring to FIG. 8, the apparatus may receive a list of tasks from user A, user B, and user C. The apparatus may determine whether it is possible to perform the tasks of user A, user B, and user C in the same place. If it is possible to perform the tasks of user A, user B, and user C in the same place, the apparatus may determine whether pick-up areas are the same as each other or whether a vehicle which provides a mobility service is on the way. If the pick-up areas are the same as each other or if the vehicle is on the way, the apparatus may suggest destinations where the tasks may be completed and may provide information about distance or cost. If the pick-up areas are different from each other or if the vehicle is not on the way, the apparatus may provide an alternative solution. If there is no alternative solution, the apparatus may schedule an individual trip.

If it is possible to perform the tasks of user A, user B, and user B in different places, the apparatus may determine whether pick-up areas are the same as each other. If the pick-up areas are the same as each other, the apparatus may suggest destinations where tasks may be completed and may provide information about distance or cost. If the pick-up areas are different from each other, the apparatus may determine whether pick-up locations are arranged to an area meeting interests. For example, the apparatus may determine whether delivering the users to a plurality of destinations for performing a plurality of tasks via a plurality of pick-up locations excessively increases time and/or cost. If the pick-up location is suitable, the apparatus may suggest destinations where tasks may be completed and may provide information about distance or cost. If the pick-up location is not suitable, the apparatus may schedule an individual trip.

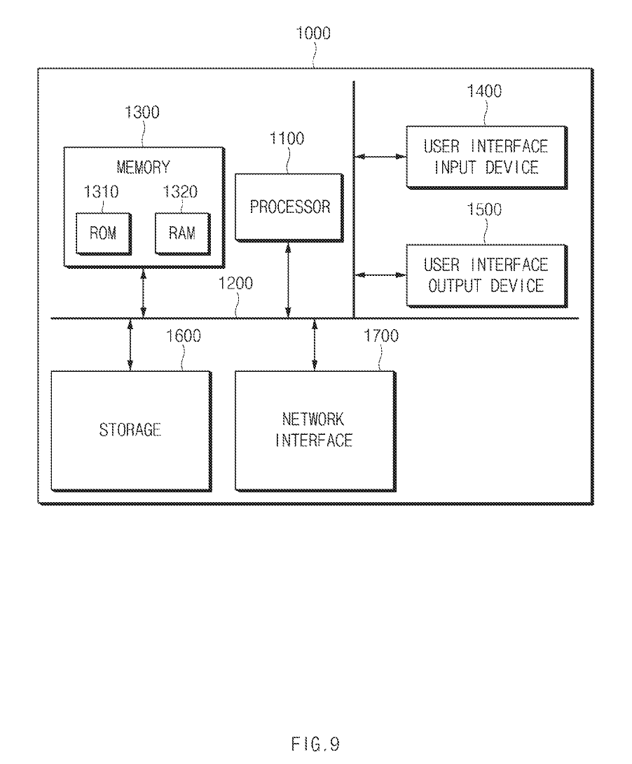

FIG. 9 is a block diagram illustrating a configuration of a computing system according to an embodiment of the present disclosure.

Referring to FIG. 9, the user input processing method according to an embodiment of the present disclosure may be implemented through the computing system. A computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for executing processing of instructions stored in the memory 1300 and/or the storage 1600. Each of the memory 1300 and the storage 1600 may include various types of volatile or non-volatile storage media. For example, the memory 1300 may include a read only memory (ROM) 1310 and a random access memory (RAM) 1320.

Thus, the operations of the methods or algorithms described in connection with the embodiments disclosed in the specification may be directly implemented with a hardware module, a software module, or combinations thereof, executed by the processor 1100. The software module may reside on a storage medium (i.e., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component of the user terminal.

The apparatus and method for scheduling the trip for the plurality of users may enhance availability of the mobility service and may reduce the cost of using the mobility service by classifying a user group based on a task the user wants to perform and providing the trip.

In addition, various effects indirectly or directly ascertained through the present disclosure may be provided.

While the present disclosure has been described with reference to exemplary embodiments, it will be apparent to those skilled in the art that various changes and modifications may be made without departing from the spirit and scope of the present disclosure.

Therefore, exemplary embodiments of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. An apparatus for scheduling a trip for a plurality of users, the apparatus comprising:
a communication circuit configured to communicate with a plurality of terminals of the plurality of users;
a memory; and
a processor configured to be electrically connected with the communication circuit and the memory,
wherein the processor is configured to:
obtain information about a location of each of the plurality of terminals and information about a task to be performed by each of the plurality of users from the plurality of terminals;
classify the plurality of users into a user group based on the information about the location and the information about the task; and
provide a trip for the classified user group based on locations and tasks of users included in the classified user group.

2. The apparatus of claim 1, wherein the processor is further configured to:
classify a task to be performed by each of the plurality of users based on the information about the location; and
if there is a trip corresponding to the classified task, the trip being stored in the memory, provide the trip, which corresponds to the classified task, to a terminal of a user to perform the classified task.

3. The apparatus of claim 1, wherein the processor is further configured to:
classify users, who have a same pick-up location, among the plurality of users into one user group.

4. The apparatus of claim 1, wherein the processor is further configured to:
classify users who have tasks performable in a same destination into one user group.

5. The apparatus of claim 1, wherein the processor is further configured to:
provide the trip based on similarity of the locations and similarity of the tasks between the users included in the classified user group.

6. The apparatus of claim 1, wherein the processor is further configured to:
suggest one or more destinations for the users to perform the tasks based on the locations and the tasks of the users included in the classified user group; and
provide the trip for the users to arrive at a destination selected by at least a part of the users among the one or more destinations.

7. The apparatus of claim 6, wherein the processor is further configured to:
provide information associated with time and cost required for each of the users to arrive at each of the one or more destinations.

8. The apparatus of claim 1, wherein the processor is further configured to:
group users who have a same pick-up location and have tasks achievable in a same destination, users who have the same pick-up location and have tasks achievable in different destinations, users who have different pick-up locations and have tasks achievable in the same destination, or users who have the different pick-up locations and have tasks achievable in the different destinations, among the plurality of users based on the information about the location and the information about the task.

9. The apparatus of claim 1, wherein the processor is further configured to:
if the users included in the classified user group have the same pick-up location and have tasks achievable in the same destination, suggest that one of the users performs a task of each of the users.

10. The apparatus of claim 9, wherein the processor is further configured to:
suggest that the rest of the users pay cost for the trip.

11. The apparatus of claim 1, wherein the processor is further configured to:
if the users included in the classified user group have a same pick-up location and have tasks achievable in a same destination, suggest one or more destinations for performing the tasks based on the same pick-up location.

12. The apparatus of claim 1, wherein the processor is further configured to:
if the users included in the classified user group have a same pick-up location and have tasks achievable in a same destination and if information about a destination designated by one of the users included in the classified user group is obtained, provide the trip for the users to arrive at the designated destination.

13. The apparatus of claim 1, wherein the processor is further configured to:
if the users included in the classified user group have different pick-up locations and have tasks achievable in a same destination, suggest one or more destinations for the tasks based on a location of each of the users.

14. The apparatus of claim 1, wherein the processor is further configured to:
if the users included in the classified user group have a same pick-up location and have tasks achievable in different destinations, suggest one or more destinations for the most number of the users to perform the tasks.

15. The apparatus of claim 1, wherein the processor is further configured to:
if the users included in the classified user group have different pick-up locations and have tasks achievable in different destinations, group users within a specified distance among the users; and
suggest one or more destinations for the grouped users to perform the tasks.

16. A method for scheduling a trip for a plurality of users, the method comprising steps of:
obtaining, by a processor, information about a location of each of a plurality of terminals and information about a task to be performed by each of the plurality of users from the plurality of terminals of the plurality of users;
classifying, by the processor, the plurality of users into a user group based on the information about the location and the information about the task; and
providing, by the processor, a trip for the classified user group based on locations and tasks of users included in the classified user group.

17. The method of claim 16, further comprising steps of:
classifying a task to be performed by each of the plurality of users based on the information about the location; and
if there is a previously stored trip corresponding to the classified task, providing the trip to a terminal of a user to perform the classified task.

18. The method of claim 16, wherein the step of providing the trip for the classified user group comprises:
providing the trip based on similarity of the locations and similarity of the tasks between the users included in the classified user group.

19. The method of claim 16, wherein the step of providing the trip for the classified user group comprises:
suggesting one or more destinations for the users to perform the tasks based on the locations and the tasks of the users included in the classified user group; and
providing the trip for the users to arrive at a destination selected by at least a part of the users among the one or more destinations.

20. The method of claim 19, wherein the step of providing the trip for the classified user group further comprises:
providing information associated with time and cost required for each of the users to each of the one or more destinations.
